(19) United States
(12) Patent Application Publication
(10) Pub. No.: US 2009/0021123 A1
(43) Pub. Date: Jan. 22, 2009

(54) IMMOBILIZING SYSTEM, FOR STACKABLE MODULAR FILING CABINETS

(75) Inventor: Pedro ARRIOLA ARRIZABALAGA, ELGOIBAR (Gipuzkoa) (ES)

Correspondence Address: LUCAS & MERCANTI, LLP, 475 PARK AVENUE SOUTH, 15TH FLOOR, NEW YORK, NY, 10016, US

(73) Assignee: OJMAR, S.A., ELGOIBAR (Gipuzkoa (ES)

(21) Appl. No.: 12/278,944

(22) PCT Filed: Sep. 28, 2006
(86) PCT No.: PCT/ES2006/000544

§ 371 Date: Aug. 8, 2008

(30) Foreign Application Priority Data
Mar. 3, 2006 (ES) P-200600529

(51) Int. Cl. E05B 65/46; A47B 88/16; A47B 88/04; A47B 47/00; E05B 65/44

(52) U.S. Cl. 312/107.5; 312/221

(57) ABSTRACT

Immobilization system, for stackable modular filing cabinets, of the type which include strips (1) with moveable billets (P).

Each strip (1) has on each of the ends of its moveable billet (P), mobile blockers (2), (4) each equipped with shafts (2′), (4′) facing each other to abutment in the modular stacking of the contiguous files and on each of its own ends, fixed blockers (3), (5) crossed through by the corresponding shaft (2′), (4′) of the corresponding mobile blocker (2), (4), so that there is always mechanical continuity between shafts (2′), (4′) of two contiguous strips (1) the shafts of which (2′), (4′) meet alignedly to abutment, one being supported upon the other in continuity with the billets (P).

The object of the invention is an immobilizing system for stackable modular filing cabinets.

Currently, the use of immobilizing systems for cabinets with drawers or similar, of the type used to file documents of all types, which prevent the overturning of the cabinet when the drawers open, is widespread; there being a vast number of related Patents, among which, for example, and in addition to others, EP1059408; EP0286199; U.S. Pat. No. 4,768,844.

All known immobilizing systems refer to a unit of furniture into which a specific immobilizing unit is built.

The problem appears when it is desired that the cabinet be modular, that is, when the dimension of a specific cabinet for a specific user is obtained by the addition, in continuity, of several cabinet module-units.

Until now the cabinet could be modular, but the immobilization system is not; this is where the problem appears.

No known system has a modular immobilization system which in continuity adapts to the requirements of a modular cabinet.

The unresolved problem in current solutions is modularity: when modular cabinets are stacked the solutions for locking/immobilization with anti-overturn are independent for each module.

The object of the invention resolves this problem of modularity, allowing the use of a single anti-overturn lock system in stackable modular cabinets of the type described. For this purpose, each strip has on its ends:

a) on the ends of the moveable billet, both mobile blockers equipped with both shafts opposite each other, abutted in the modular stacking of the contiguous files;

b) on their own ends, both fixed blockers crossed by the corresponding shaft of the corresponding mobile blocker, so that there is always mechanical continuity between shafts of two contiguous strips; said shafts meet alignedly abutted, one supported upon the other in continuity with the billets.

The set of strips on its end has a return spring.

In particular, the mobile blockers and the fixed blockers are identical and are positioned opposite each other on the ends of the corresponding moveable billet of each strip. With this, problems inherent in present systems are also solved, relating to the excessive number of components and the use of complex components, which are difficult to manufacture, assemble, and operate.

The technology of known solutions is maintained to the extent that the system that is the object of the invention is of the type which includes strips with immobilization devices, all of the immobilization devices of all the drawers being correlated so that the opening of one of them prevents the opening of the rest of them.

To better understand the object of this invention, a preferred practical way of making it is shown in the diagrams, subject to additional changes which do not substantially alter their fundamentals.

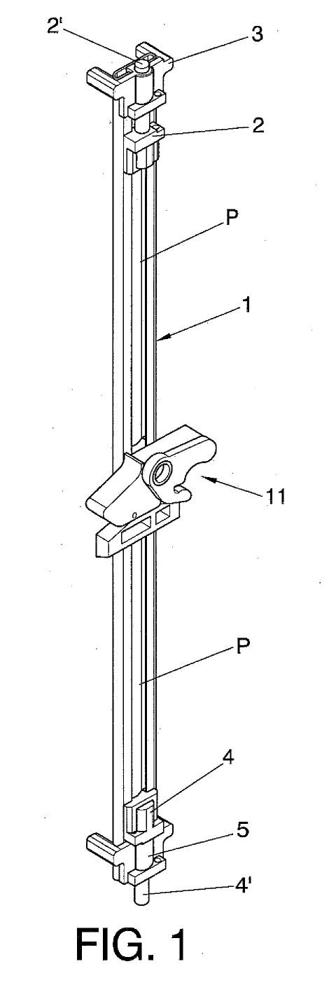

FIG. 1 is an overall schematic view of a strip (1) which includes, on its ends, the fixed blockers (3), (5) and whose moveable billets (P) include on their ends the mobile blockers (2), (4) which basically constitute the system which is the object of the invention.

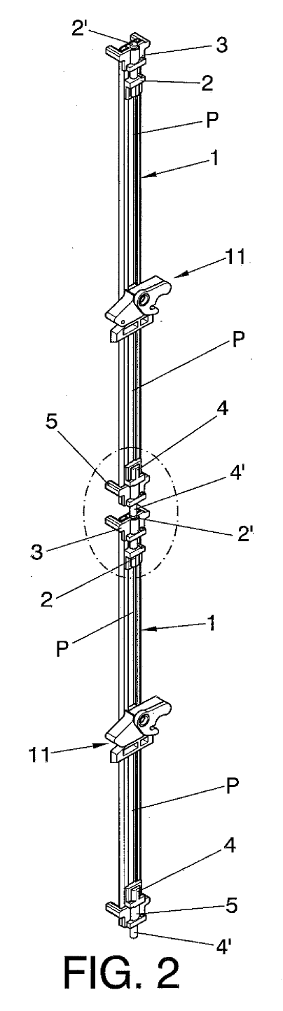

FIG. 2 is an overall view similar to FIG. 1, with two strips (1) aligned in working position.

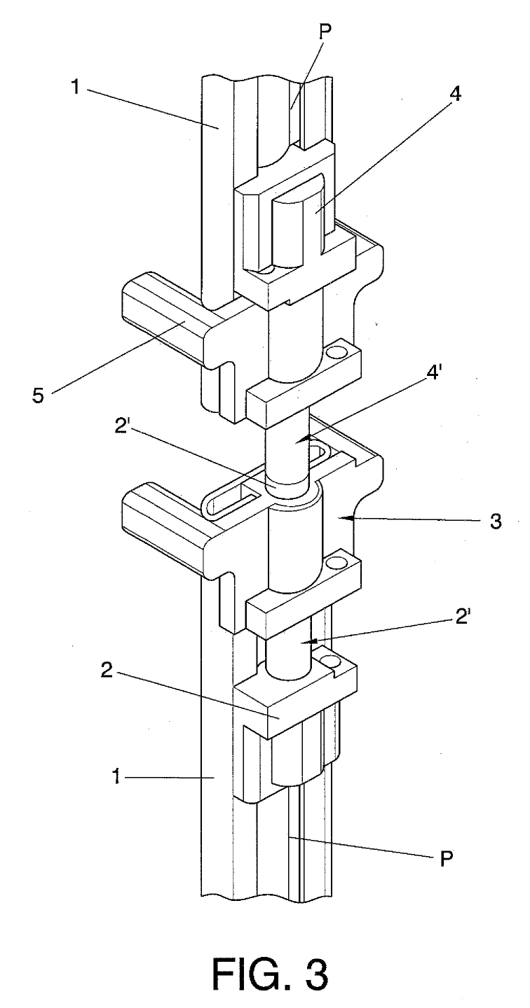

FIG. 3 is an enlarged detail, as indicated in FIG. 2.

The following is a description of an example of a practical, non-limiting way of making this invention.

The immobilizing system for stackable modular filing cabinets, according to the invention, is of the type that include strips (1) in the filing cabinet with drawers, with devices for immobilization (11) of all correlated drawers so that the opening of one of them prevents the opening of the rest of them.

In a known position the strips (1) include billets (P) which move in them. It makes no difference, and it is known, that each strip (1) incorporates a single billet (P) or several billets (P) which are moveable in continuity, meeting to abutment one upon the other.

With the use of this invention, this structuring is also applicable and operable when the filing cabinets are made up of independent, stackable modules.

According to the system which is the object of the invention, mounted in each module of filing cabinets is a strip (1) causing the strips (1) to interact in order for the system to work. For this:

The moveable billet or billets (P) of each strip (1) has on both ends mobile blockers (2), (4) each with shafts (2′), (4′) opposite each other in abutment in the modular stacking of the contiguous files.

Each strip (1) has at each end, fixed blockers (3), (5) crossed through by the corresponding shaft (2′), (4′) of the corresponding mobile blocker (2), (4) so that there is always continuity of contact between shafts (2′), (4′) of two contiguous strips (1) the shafts of which (2′), (4′) meet alignedly to abutment, one being supported upon the other.

For the system to work, there must be mechanical continuity between the billets (P) and the shafts (2′), (4′) of two contiguous strips (1). The blockers (2), (4) and their shafts (2′), (4′) move with the billets (P), while the fixed blockers (3), (5) are fixed to the strips (1).

Moreover, the set of strips (1)—there will be as many strips (1) as stacked modules—has at its end, a return spring, so that there is always continuity of contact between the shafts (2′), (4′) facing opposite each other to abutment.

In particular, the mobile blockers (2), (4) are identical and are positioned opposite each other in pairs on the ends of the corresponding billets (P) of each strip (1); so that the shaft (2′) of a blocker (2) attacks against the shaft (4′) of a blocker (4) corresponding to a billet (P) of a strip (1) mounted on a following module.

Likewise, the fixed blockers (3), (5) are identical and are positioned opposite each other in pairs on the ends of each strip (1) positioning the corresponding mobile blocker (2), (4) without preventing or hindering the free movement of their respective shafts (2′), (4′).

1-4. (canceled)

5. Immobilizing system, for stackable modular filing cabinets, comprising strips with moveable billets, provided with immobilization devices; each modular filing cabinet containing all the immobilization devices of all the drawers intercorrelated so that the opening of one of them prevents the rest from opening; wherein each strip corresponding to each modular filing cabinet has:
a) at the ends of its moveable billet, both mobile blockers each equipped with shafts facing abutted in the modular stacking of two contiguous stacked modulus files;
b) at each end, fixed blockers crossed by the corresponding shaft of the corresponding mobile blocker so that there is always mechanical continuity between shafts of two contiguous strips corresponding to two different modular filing cabinets, of which the shafts meet alignedly abutted, one being supported on the other in continuity with the strips.

6. Immobilizing system, for stackable modular filing cabinets, according to claim 5, wherein the set of strips of all the stacked modular filing cabinets have at their end, a return spring.

7. Immobilizing system, for stackable modular filing cabinets, according to claim 5, wherein the mobile blockers are identical and are positioned opposite each other on the ends of the corresponding moveable strip of each billet of the same modular filing cabinet.

8. Immobilizing system, for stackable modular filing cabinets, according to claim 5, wherein the fixed blockers are identical and are positioned opposite each other on the ends of each billet of the same modular filing cabinet.
